(19) United States
(12) Patent Application Publication
(10) Pub. No.: US 2022/0224735 A1
(43) Pub. Date: Jul. 14, 2022

(54) INFORMATION PROCESSING APPARATUS, NON-TRANSITORY COMPUTER READABLE MEDIUM STORING PROGRAM, AND METHOD

(71) Applicant: FUJIFILM Business Innovation Corp., Tokyo (JP)

(72) Inventor: Kengo TOKUCHI, Kanagawa (JP)

(73) Assignee: FUJIFILM Business Innovation Corp., Tokyo (JP)

(21) Appl. No.: 17/383,399

(22) Filed: Jul. 22, 2021

(30) Foreign Application Priority Data
Jan. 14, 2021 (JP) 2021-004369

(51) Int. Cl. H04L 29/06; G06K 9/00; G10L 17/22; G10L 25/78

(52) U.S. Cl. CPC H04L 65/403; G10L 25/78; G10L 17/22; G06K 9/00228

(57) ABSTRACT

An information processing apparatus includes a processor configured to, in a case where another user other than a user logging in to an online conference speaks in the online conference, show that the other user is speaking, in the online conference.

### CROSS-REFERENCE TO RELATED APPLICATIONS

This application is based on and claims priority under 35 USC 119 from Japanese Patent Application No. 2021-004369 filed Jan. 14, 2021.

### BACKGROUND

### (i) Technical Field

The present invention relates to an information processing apparatus, a non-transitory computer readable medium storing a program, and method.

### (ii) Related Art

JP2012-146072A discloses an apparatus that specifies the next speaker in a remote conference via a network.

JP2017-34312A discloses an apparatus as follows. The apparatus receives an input of a voice in a base in which a communication device is disposed, and photographs the inside of the base. In a case where speaking is performed in the base, the apparatus records a speaking point indicating a position of a speaker along with a time point. In a case where a plurality of speaking points in the base are recorded within a predetermined time, the apparatus determines a photographing range including the plurality of recorded speaking points, and transmits a video of the determined photographing range to another communication device disposed in another base.

JP2001-274912A discloses an apparatus for recognizing a speaker and the partner in a case where three or more persons in remote places hold a voice conference using a telephone line.

JP2013-105374A discloses an apparatus as follows. The apparatus detects a state in which the conversation between participants in a conference is established, and records voices of the participants in the conference. The apparatus extracts a specific voice from the recorded voices based on the detection result of the state in which the conversation is established, and creates the minutes of the conference by using the specific voice.

JP2009-33594A discloses a system that relaxes restrictions on a speaker capable of speaking while switching the speaker with the progress of a conference.

JP2020-141208A discloses a system that constructs a shared conference room normally used by terminals and an individual conference room for individually using a specific group among the terminals and provides a voice conference for each conference room to which each terminal belongs.

### SUMMARY

Aspects of non-limiting embodiments of the present disclosure relate to an information processing apparatus and a non-transitory computer readable medium storing a program for specifying a user who is speaking in an online conference even though each individual user participating in the online conference does not use a microphone.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including a processor configured to, in a case where another user other than a user logging in to an online conference speaks in the online conference, show that the other user is speaking, in the online conference.

### BRIEF DESCRIPTION OF THE DRAWINGS

Exemplary embodiment(s) of the present invention will be described in detail based on the following figures, wherein:

FIG. 1 is a block diagram illustrating a configuration of an information processing system according to an exemplary embodiment;

FIG. 2 is a block diagram illustrating a configuration of a server according to the present exemplary embodiment;

FIG. 3 is a block diagram illustrating a configuration of a terminal device according to the present exemplary embodiment;

FIG. 4 is a diagram illustrating a user in a place α;

FIG. 5 is a diagram illustrating a user in a place β;

FIG. 6 is a diagram illustrating a user in a place γ;

FIG. 7 is a diagram illustrating a screen;

FIG. 8 is a diagram illustrating a screen;

FIG. 9 is a diagram illustrating a screen;

FIG. 10 is a diagram illustrating the screen;

FIG. 11 is a diagram illustrating the screen;

FIG. 12 is a diagram illustrating the screen;

FIG. 13 is a diagram illustrating the screen;

FIG. 14 is a diagram illustrating the screen; and

FIG. 15 is a diagram illustrating the screen.

### DETAILED DESCRIPTION

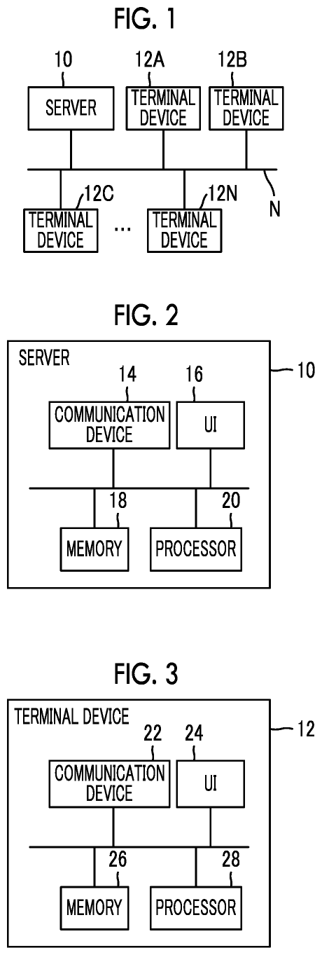

An information processing system according to an exemplary embodiment will be described with reference to FIG. 1. FIG. 1 illustrates an example of a configuration of the information processing system according to the present exemplary embodiment.

The information processing system according to the present exemplary embodiment includes, for example, a server 10 and N (N is an integer of 1 or more) terminal devices. In the example illustrated in FIG. 1, the information processing system according to the present exemplary embodiment includes terminal devices 12A, 12B, 12C, . . . , and 12N. The number of terminal devices illustrated in FIG. 1 is just an example. One or a plurality of terminal devices may be provided in the information processing system according to the present exemplary embodiment. In a case where it is not necessary to distinguish the terminal devices 12A, 12B, 12C, . . . , and 12N from each other, the terminal devices are referred to as a “terminal device 12” below. The information processing system according to the present exemplary embodiment may include devices other than the server 10 and the terminal device 12.

The server 10 and each terminal device 12 have a function of communicating with other devices. The communication may be a wired communication using a cable or a wireless communication. That is, each device may be physically connected to another device by the cable to transmit and receive information, or may transmit and receive information by a wireless communication. A wireless communication includes, for example, a short-range wireless communication, Wi-Fi (registered trademark), and the like. The short-range wireless communication includes, for example, Bluetooth (registered trademark), the radio frequency identifier (RFID), NFC, and the like. For example, each device may communicate with another device via a communication path N such as a local area network (LAN) or the Internet.

The server 10 provides an online service via the communication path N. A user can use the online service by using the terminal device 12. For example, the user can use the online service to transmit information such as a sound, an image, a moving image, a text string, and vibration to the partner.

Examples of the online service include an online conference, a service for providing contents online, an online game, an online shopping, a social network services (SNS), and combinations thereof. The online conference may be referred to as a web conference, a remote conference, a video conference, and the like. Examples of the contents include entertainment (for example, concerts, plays, movies, moving images, music, and the like), sports, and e-sports. For example, a moving-image distribution service and a music distribution service are examples of the service for providing contents online. The user can watch entertainment online or watch sports and e-sports.

The online service may be a service using a virtual space or a service not using the virtual space. The virtual space has a concept that contrasts with the real space. Examples of the virtual space include a virtual space realized by a computer, a virtual space formed on a network such as the Internet, a virtual space realized by the virtual reality (VR) technology, and a cyber space. For example, a virtual three-dimensional space or a two-dimensional space corresponds to an example of the virtual space.

The server 10 stores and manages account information of a user who uses the online service. The account information is information for logging in to the online service to use the online service, and is, for example, information including a user ID and a password. For example, by transmitting the account information to the server 10 and logging in to the online service, the user associated with the account information is permitted to participate in the online service and use the online service. The user may be able to use the online service without registering the own account information in the online service. The user may be able to use the online service without logging in to the online service.

Examples of the terminal device 12 include a personal computer (referred to as a “PC” below), a tablet PC, a smartphone, a wearable device (for example, augmented reality (AR) glasses, virtual reality (VR) glasses, and hearable device) or a portable phone.

An automatic response partner such as a chatbot may participate in the online service. For example, the automatic response partner functions as a response assistant that responds to an inquiry of the user. The automatic response partner receives an utterance of the user, analyzes the content of the utterance, creates a response and the like to the utterance, and notifies the user of the created response. The automatic response partner is realized, for example, by executing a program. The program is stored in, for example, the server 10 or another device (for example, another server or terminal device 12). The automatic response partner may be realized by artificial intelligence (AI). Any algorithm used for the artificial intelligence may be used.

In the following description, as an example, it is assumed that an online conference is used by a user, and a sound, an image, a moving image, a text string, vibration, or the like is transmitted to the communication partner by the online conference.

The hardware configuration of the server 10 will be described below with reference to FIG. 2. FIG. 2 illustrates an example of the hardware configuration of the server 10.

The server 10 includes, for example, a communication device 14, a UI 16, a memory 18, and a processor 20.

The communication device 14 is a communication interface having a communication chip, a communication circuit, and the like. The communication device has a function of transmitting information to another device and a function of receiving information from the other device. The communication device 14 may have a wireless communication function or a wired communication function. The communication device 14 may communicate with another device by using, for example, short-range wireless communication, or may communicate with another device via the communication path N.

The UI 16 is a user interface and includes at least one of a display or an input device. The display is a liquid crystal display, an EL display, or the like. The input device is a keyboard, a mouse, an input key, an operation panel, or the like. The UI 16 may be a UI such as a touch panel having both the display and the input device.

The memory 18 is a device that forms one or a plurality of storage regions for storing various types of information. Examples of the memory 18 include a hard disk drive, various types of memories (for example, RAM, DRAM, and ROM), other storage devices (for example, optical disk), and a combination thereof. One or a plurality of memories 18 are included in the server 10.

The processor 20 is configured to control the operation of the units in the server 10. The processor 20 may include a memory. For example, the processor 20 provides the online service for the user.

The hardware configuration of the terminal device 12 will be described below with reference to FIG. 3. FIG. 3 illustrates an example of the hardware configuration of the terminal device 12.

The terminal device 12 includes, for example, a communication device 22, a UI 24, a memory 26, and a processor 28.

The communication device 22 is a communication interface having a communication chip, a communication circuit, and the like. The communication device has a function of transmitting information to another device and a function of receiving information transmitted from the other device. The communication device 22 may have a wireless communication function or a wired communication function. The communication device 22 may communicate with another device by using, for example, short-range wireless communication, or may communicate with another device via the communication path N.

The UI 24 is a user interface and includes at least one of a display or an input device. The display is a liquid crystal display, an EL display, or the like. The input device is a keyboard, a mouse, an input key, an operation panel, or the like. The UI 24 may be a UI such as a touch panel having both the display and the input device.

The terminal device 12 may include an image pickup device such as a camera, a microphone, and a speaker. All or some of the above devices may be connected to the terminal device 12. Earphones or headphones may be connected to the terminal device 12.

The memory 26 is a device that forms one or a plurality of storage regions for storing various types of information. Examples of the memory 26 include a hard disk drive, various types of memories (for example, RAM, DRAM, and ROM), other storage devices (for example, optical disk), and a combination thereof. One or a plurality of memories 26 are included in the terminal device 12.

The processor 28 is configured to control the operation of the units in the terminal device 12. The processor 28 may include a memory.

For example, the processor 28 displays an image, a moving image, a text string, and the like transmitted by an online conference, on the display of the terminal device 12, outputs a sound transmitted by the online conference, from a speaker, transmits an image, a moving image, and the like generated by image pickup of the camera, to the partner by the online conference, or transmits a sound collected by the microphone to the partner by the online conference.

The terminal device 12 may include at least one of various sensors such as a sensor (for example, global positioning system (GPS) sensor) that acquires position information of the terminal device 12, a gyro sensor that detects the orientation and the posture, or an acceleration sensor.

Examples of the present exemplary embodiment will be described below. The processor 20 of the server 10 or the processor 28 of the terminal device 12 may perform processing according to each example. The processor 20 and the processor cooperate with each other to perform the processing according to each example. The processor 20 may perform a portion of certain processing, and the processor 28 may perform other portions of the processing. The server 10, the terminal device 12, or a combination thereof corresponds to an example of the information processing apparatus according to the present exemplary embodiment.

In the present exemplary embodiment, a plurality of users are in the same place, and an online conference is used in this place. The place is not particularly limited, and may be a closed space (for example, room or conference room) or an open space (for example, outdoors).

### EXAMPLE 1

Example 1 will be described below. As an example, the same online conference is used in a place α, a place β, and a place γ. For example, the same online conference is used in the place α, the place β, and the place γ by using the terminal device 12 provided in each of the place α, the place β, and the place γ. A user in the place α, a user in the place β, and a user in the place γ can transmit and receive information to and from each other by using the same online conference. The number of places is just an example.

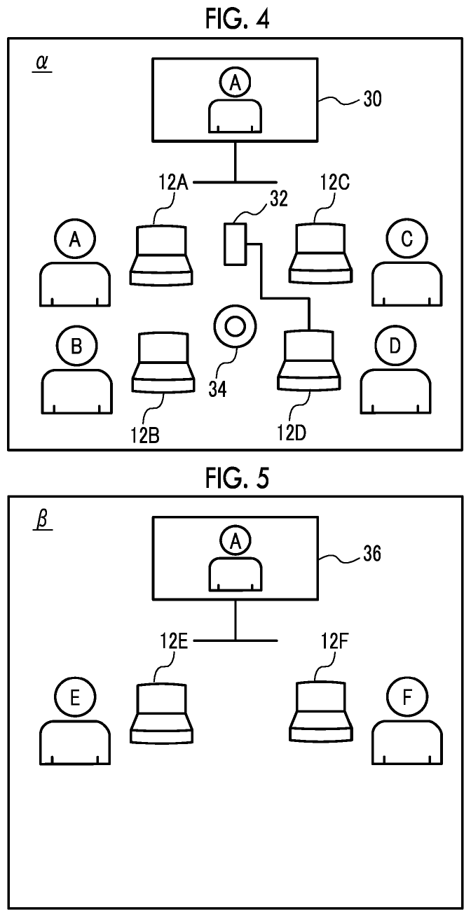

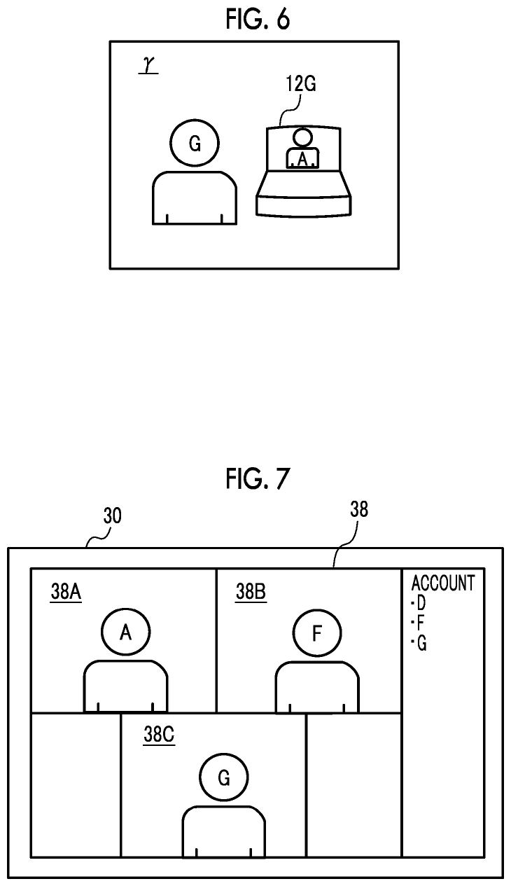

FIG. 4 illustrates the user in the place α. FIG. 5 illustrates the user in the place β. FIG. 6 illustrates the user in the place γ. The place α, the place β, and the place γ are different places.

As illustrated in FIG. 4, four users (for example, users A, B, C, D) are in the place α. As illustrated in FIG. 5, two users (for example, users E and F) are in the place β. As illustrated in FIG. 6, one user (for example, user G) is in the place γ. As described above, a plurality of users are in the place α and the place β. The number of users in each place is just an example.

The user A uses the terminal device 12A. The user B uses the terminal device 12B. The user C uses the terminal device 12C. The user D uses the terminal device 12D. The user E uses the terminal device 12E. The user F uses the terminal device 12F. The user G uses the terminal device 12G. Each terminal device 12 may include a camera, a microphone, and a speaker.

A display 30, a microphone 32, and a camera 34 are provided in the place α. The speaker may be provided in the place α. The display 30, the microphone 32, the camera 34, and the speaker are shared by the users A, B, C, and D in the place α and are used in an online conference. For example, a screen for an online conference is displayed on the display 30, and an image or the like of a user participating in the online conference is displayed on the screen.

A display 36 is provided in the place β. A microphone, a camera, and a speaker may also be provided in the place β, and shared by the users E and F. The display 36, the microphone, the camera, and the speaker are used in an online conference. For example, a screen for an online conference is displayed on the display 36.

A display, a microphone, a camera, and a speaker may also be provided in the place γ, and used in an online conference.

For example, the same place may be determined based on an IP address of each terminal device 12. The same place may be determined based on a physical position of each user or each terminal device 12, or based on position information acquired by the GPS. The same place may be determined by using a microphone or a speaker or by each user informing the own place.

For example, the processor 20 of the server 10 gathers a plurality of terminal devices 12 having IP addresses close to each other into one group. The processor 20 estimates that the plurality of terminal devices 12 are installed in the same place, and estimates that a plurality of users using the plurality of terminal devices 12 are in the same place. For example, in a case where user identification information (for example, user ID and account information) for identifying a user who uses the terminal device 12 is registered in the terminal device 12, the processor 20 of the server 10 identifies the user who uses the terminal device 12, based on the user identification information. For example, in a case where the IP addresses assigned to the terminal devices 12A, 12B, 12C, and 12D are closer to each other than the IP addresses assigned to the terminal devices 12E, 12F, and 12G, the processor 20 of the server 10 estimates that the terminal devices 12A, 12B, 12C, and 12D are installed in the same place α, and that the users A, B, C, and D are in the same place α.

As another example, the physical position of each user maybe designated by a text string, a figure, or the like. For example, an image representing the layout of the seats in each place is displayed on the display, and the user designates the own seat or the seat of another user on the image. The processor 20 of the server 10 recognizes the place of each user based on the designation. For example, in a case where the user A designates the seat of each of the users A, B, C, and D on an image representing the layout of the seats in the place α, the processor 20 of the server 10 recognizes that the users A, B, C, and D are in the same place α. In a case where the user A designates the seat of each of the users A, B, C, and D and assigns the user identification information of each of the users A, B, C, and D to the seat of the corresponding user, the server 10 of the processor 20 manages the position of the seat of the user in association with the user identification information of the user. Thus, a user on each seat is managed.

As another example, the processor 20 of the server 10 may detect the position of each user who uses the terminal device 12, based on the position information (for example, position information acquired by the GPS) of each terminal device 12. The processor 20 may determine whether or not the users are in the same place, based on the position of each user. For example, in a case where the position information of each of the users A, B, C, and D indicates a position in the place α, the processor 20 of the server 10 estimates that the users A, B, C, and D are in the same place α. The processor 20 of the server 10 may estimate a plurality of users having positions which are close to each other in comparison to the positions of other users, as users in the same place. For example, in a case where the positions of the users A, B, C, and D are close to each other in comparison to the positions of the user E, F, and G, the processor 20 of the server 10 estimates that the users A, B, C, and D are in the same place.

As another example, the processor 20 of the server 10 may determine whether or not the users are in the same place, based on the on/off of the microphone or the speaker and the position information of each user. For example, each user wears a microphone, or the terminal device 12 of each user is provided with a microphone. The processor 20 of the server 10 detects the position of each user by using the GPS or the like, and also detects whether the microphone of each user is on or off. In a case where the microphone of only one of the plurality of users at a distance close to each other is on, the processor 20 of the server 10 estimates the plurality of users as one group, and estimates that the plurality of users are in the same place. The processor 20 may determine whether or not the plurality of users are in the same place, based on the on/off of the speaker instead of the microphone. In a case where the user wears earphones or headphones as the speaker, it is usually assumed that the speaker is in the on state. Thus, it is considered that it is difficult to estimate a group based on the speakers. In this case, the group is estimated based on the on/off of the microphone.

As another example, the user may voluntarily inform a place where the user is. For example, the user may input the place where the user is, with the own terminal device 12, or may speak “in XX” at a time point of starting an online conference. The processor 20 of the server 10 may receive the input and detect the place where each user is, or may receive the utterance and detect the place where each user is.

The processor 28 of the terminal device 12 may perform processing by the processor 20 of the server 10 described above, so as to determine a place where each user is.

In the following description, as an example, the users D, F, and G log in to the same conference and participate in the conference. For example, the user D logs in to the online conference and participates in the online conference by using the terminal device 12D. The user F logs in to the online conference and participates in the online conference by using the terminal device 12F. The user G logs in to the online conference and participates in the online conference by using the terminal device 12G. A plurality of users may log in to the online conference using the same terminal device 12 to participate in the online conference.

The users A, B, and C may participate in the online conference in the same place α to the place of the user D, without logging in to the online conference. The user D participates in the online conference in the same place β to the place of the user E, without logging in to the online conference. For example, a user who is permitted to participate by a logged-in user may be able to participate in the online conference without logging in.

A display region formed on a screen for an online conference is assigned to a user who logs in to the online conference. In the display region, an image or a moving image generated by photographing of the camera associated with the display region, or an image or a moving image (for example, icon or avatar) schematically representing the user assigned to the display region is displayed. An image or a moving image maybe displayed, or a text string for identifying a user (for example, name, user ID, account, or nickname) maybe displayed without displaying the image or the moving image. The display region is not assigned to a user who is not logged in to the online conference.

For example, a screen for an online conference is displayed on the display of each of the terminal devices 12D, 12F, and 12G logged in to the online conference. The display region assigned to the user D, the display region assigned to the user F, and the display region assigned to the user G are displayed on the screen for the online conference.

The display 30 is used in the online conference in the place α. The display 36 is used in the online conference in the place β. The screen for the online conference is displayed on the displays 30 and 36. For example, the display 30 is connected to the terminal device 12D and used in the online conference. The display 36 is connected to the terminal device 12F and used in the online conference.

The screen for the online conference may also be displayed on the display of the terminal device 12 of the user who is not logged in to the online conference. For example, the screen for the online conference is displayed on the display of the terminal device 12 of the user participating in the online conference in which the users D, F, and G participate, without logging in. Thus, the user participating in the online conference without logging in can share the screen for the online conference.

In the following description, as an example, the screen for the online conference is displayed on the display of the terminal device 12 of each user and the displays 30 and 36.

For example, the camera 34 installed in the place α is associated with the user D who is logged in to the online conference and participates in the online conference in the place α. An image or a moving image generated by photographing of the camera 34 is displayed in the display region assigned to the user D on the screen for the online conference. For example, the camera 34 is connected to the terminal device 12D. Data of an image or a moving image generated by photographing of the camera 34 is transmitted to each terminal device 12 via the terminal device 12D and the server 10. Then, the data is displayed on the screen for the online conference on the display of each terminal device 12. An image or a moving image generated by photographing of the camera of the terminal device 12D (that is, built-in camera) instead of the camera 34 may be displayed on the screen for the online conference. Instead of the image or the moving image generated by photographing of the camera 34, an image or a moving image schematically representing the user D may be displayed, or a text string for identifying the user D may be displayed.

Similarly, the camera on the terminal device 12F (that is, built-in camera) or the camera installed in the place β is associated with the user F who is logged in to the online conference and participates in the online conference in the place β. An image or a moving image generated by photographing of the camera is displayed in the display region assigned to the user F on the screen for the online conference. Instead of the image or the moving image generated by photographing of the camera, an image or a moving image schematically representing the user F may be displayed, or a text string for identifying the user F may be displayed.

Similarly, the camera on the terminal device 12G (that is, built-in camera) or the camera installed in the place γ is associated with the user G who is logged in to the online conference and participates in the online conference in the place γ. An image or a moving image generated by photographing of the camera is displayed in the display region assigned to the user G on the screen for the online conference. Instead of the image or the moving image generated by photographing of the camera, an image or a moving image schematically representing the user G maybe displayed, or a text string for identifying the user G may be displayed.

The microphone 32 installed in the place α is connected to the terminal device 12D. Data of a sound collected by the microphone 32 is transmitted to the terminal devices 12F and 12G via the terminal device 12D and the server 10. The sound is output from the respective speakers (that is, built-in speakers) of the terminal devices 12F and 12G or from a speaker (that is, external speaker) connected to each of the terminal devices 12F and 12G. Instead of the microphone 32, the microphone of the terminal device 12D may be used, or the microphones of the terminal devices 12A, 12B, and 12C may be used.

Similarly, data of a sound collected by the microphone (that is, built-in microphone) of the terminal device 12F or the microphone provided in the place β is transmitted to the terminal devices 12D and 12G via the terminal device 12F and the server 10. The sound is output from the respective speakers (that is, built-in speakers) of the terminal devices 12D and 12G or from a speaker (that is, external speaker) connected to each of the terminal devices 12D and 12G.

Similarly, data of a sound collected by the microphone (that is, built-in microphone) of the terminal device 12G or the microphone provided in the place γ is transmitted to the terminal devices 12D and 12F via the terminal device 12G and the server 10. The sound is output from the respective speakers (that is, built-in speakers) of the terminal devices 12D and 12F or from a speaker (that is, external speaker) connected to each of the terminal devices 12D and 12F.

The microphone and the speaker may be attached to the user. For example, in a case where the terminal device 12 is a wearable device such as a hearable device, it is considered that the user wears and uses the terminal device 12. In this case, the speaker (for example, earphones or headphones) included in the terminal device 12 is attached to the ear of the user, and the microphone included in the terminal device 12 is disposed near the mouth of the user.

In a case where the other user other than the user logging in to the online conference speaks in the online conference, the processor 20 of the server 10 shows that the other user is speaking, in the online conference. The processor 20 of the server 10 may generate a visual change indicating that the other user is speaking (for example, display of an image, a moving image, or a text string indicating that the other user is speaking) . The processor 20 may generate a sound indicating that the other user is speaking (for example, voice indicating the name, the user ID, the account, or the like of the other user) . The processor 20 may show that the other user is speaking, by vibration. For example, in a case where each user wears a hearable device, the processor 20 of the server 10 transmits a message indicating that the other user is speaking, to each user by bone conduction.

For example, in a case where an image or a moving image representing the other user who is speaking is not displayed on the screen for the online conference, the processor 20 of the server 10 displays the image or the moving image representing the other user who is speaking, on the screen for the online conference. In this case, the processor 20 of the server 10 may separately display an image or a moving image representing the other user who is speaking, and an image or a moving image representing a user who does not speak. For example, the processor 20 of the server 10 may display the image or the moving image representing the other user who is speaking, on the screen for the online conference so as to be larger than the image or the moving image representing a user who does not speak. The processor 20 may decorate the image or the moving image representing the other user who is speaking (for example, enclose the image or the moving image in a frame of a specific color or shape). The processor 20 may blink the image or the moving image representing the other user who is speaking. The processor 20 may highlight the image or the moving image representing the other user who is speaking, by other methods.

For example, in a case where the user A who is not logged in to the online conference speaks in the place α, that is, in a case where the user A who is in the same place α to the place of the user D logged in to the online conference speaks, the processor 20 of the server 10 displays an image or a moving image representing the user A on the screen for the online conference. For example, the image or the moving image representing the user A is displayed on the display 30 as illustrated in FIG. 4, displayed on the display 36 as illustrated in FIG. 5, and displayed on the display of the terminal device 12G as illustrated in FIG. 6. In a case where the screen for the online conference is displayed on the display of each of the terminal devices 12A to 12F, the image or the moving image representing the user A is also displayed on the display of each of the terminal devices 12A to 12F. As described above, the image or the moving image representing the user A may be displayed prominently.

The image or the moving image representing the user A maybe displayed, or a sound, vibration, or the like indicating that the user A speaks may be generated without displaying the image or the moving image representing the user A.

For example, in a case where the microphone 32 has directivity, the processor 20 of the server 10 can detect the direction in which the sound is generated in the place α, based on the sound collected by the microphone 32. The processor 20 of the server 10 can detect the position of each user based on the position (for example, position of the seat of each user) of each user registered in advance or the position of each terminal device 12 acquired by the GPS. In a case where the user A is in the direction in which the sound is generated, the processor 20 of the server 10 estimates that the user A speaks, and generates an image, a voice, a vibration, or the like indicating that the user A is speaking.

As another example, the processor 20 of the server 10 may identify the speaking user based on information on the face of the user. For example, an image representing the face of each user participating in the online conference is registered in the server 10 in advance. Information for identifying the user is associated with the image representing the face of the user. For example, an image representing the face of the user A is associated with the information for identifying the user A and registered in advance in the server 10. The face of each user is photographed by the camera, and the processor 20 of the server 10 estimates the user who is speaking, based on an image or a moving image generated by the photographing. For example, the processor 20 of the server 10 estimates that a user of which the mouth moves is a user who is speaking. The processor 20 of the server 10 collates an image representing each user and registered in advance with an image or a moving image which is generated by photographing and represents a user estimated to speak. In this manner, the processor 20 identifies the user estimated to speak.

For example, the inside of the place α is photographed by the camera 34. In a case where the user A is speaking, the processor 20 of the server 10 estimates that the user A is speaking, based on an image or a moving image generated by the photographing of the camera 34. The processor 20 collates the image or the moving image of the user A generated by the photographing with the image of the user A registered in advance in the server 10. In this manner, the processor 20 recognizes that the speaking user is the user A.

As another example, the processor 20 of the server 10 may identify the speaking user based on the voice of the user. For example, the voice of each user participating in the online conference is registered in advance in the server 10. The information for identifying the user is associated with the voice of the user. For example, the voice representing the user A is associated with the information for identifying the user A and registered in advance in the server 10. In a case where the voice of the user who speaks is collected by the microphone, the processor 20 of the server 10 collates the collected voice with the voice of each user registered in the server 10. In this manner, the processor 20 identifies the speaking user.

The processor 20 of the server 10 may cause the camera to be directed to the user who is speaking, and to photograph the user who is speaking. For example, in a case where the user A is speaking, the processor 20 of the server 10 photographs the user A by causing the camera 34 to be directed to the user A. Then, the processor 20 displays an image or a moving image generated by the photographing, on the screen for the online conference. In a case where the camera 34 is connected to the terminal device 12 (for example, terminal device 12D), the processor 28 of the terminal device 12 may photograph the user A by causing the camera 34 to be directed to the user A.

In the above example, the processor 20 of the server 10 identifies the user who is speaking, but the processor 28 of the terminal device 12 may identify the user who is speaking. For example, in a case where the user A is speaking, the processor 28 of the terminal device 12 (for example, terminal device 12D) provided in the place α may identify the user A who is speaking.

The image or the moving image representing the user who is speaking (for example, image or moving image representing the user A) may be an image or a moving image registered in advance in the server 10, or an image or a moving image generated by photographing of the camera when the user speaks. An image or a moving image (for example, icon or avatar) schematically representing the user who is speaking may be displayed.

As described above, in a case where a user (for example, user A) other than the user logged in to the online conference speaks, it is shown that the other user is speaking, and this is transmitted to each user participating in the online conference. Thus, it is possible to specify a user who is speaking in the online conference even though each user does not use a microphone. That is, it is possible to specify a user who is speaking even though the speaking user is not specified based on the sound collected by the microphone used for each user. For example, in a case where at least one microphone (for example, microphone 32 in the place α) provided at the same place (for example, place α) is turned on, the user who is speaking can be specified.

The user D logged in to the online conference and the users A, B, and C who are not logged in to the online conference are users who share at least one device used for participating in the online conference. For example, the display 30 used in the online conference is provided in the place α, and the users A, B, C, and D share the display 30 to participate in the online conference. The microphone 32, the camera 34, and the speaker used in the online conference are provided in the place α. The users A, B, C, and D share the microphone 32, the camera 34, and the speaker to participate in the online conference. As described above, the users A, B, C, and D in the same place α share the same display 30, microphone 32, camera 34, and speaker provided in the place α, and the user in another place β or γ does not share the display 30, the microphone 32, the camera 34, and the speaker provided in the place α with the users A, B, C, and D. This is similarly applied to the place β and the place γ.

The processor 20 of the server 10 may cause the user who is speaking without logging in to the online conference to log in to the online conference. For example, in a case where the user A speaks when the user A does not log in to the online conference, the processor 20 of the server 10 causes the user A to log in to the online conference. In a case where the account information of the user A is registered in the server 10 in advance, the processor 20 of the server 10 changes the logged-in state of the user A from the not-logged-in state to the logged-in state. As another example, the processor 20 of the server 10 may display a login screen on the display of the terminal device 12A to urge the user A to perform login. The user A can input the account information on the login screen to log in to the online conference. The processor 28 of the terminal device 12 may cause the user who is speaking without logging in to the online conference, to log in to the online conference. For example, in a case where the user A is speaking, the processor 28 of the terminal device 12A may cause the user A to log in to the online conference.

In a case where sound collection is performed by the microphone when the user does not speak, the processor 20 of the server 10 may estimate that a user (who is in the same place to the place of this user) other than this user is speaking. The processor 20 of the server 10 determines whether or not each user is speaking, based on the image or the moving image generated by photographing of the camera. For example, the face of the user who uses the terminal device 12 is photographed by the camera of the terminal device 12 (for example, in-camera or the like), and the processor 20 of the server 10 determines whether or not the user using the terminal device 12 is speaking, based on the image or the moving image generated by the photographing. For example, the number of users in the same place is registered in the server 10. The processor 20 of the server 10 determines whether or not each user is speaking, subtracts the number of non-speaking users from the registered number of users, and estimates the remaining one user to be the speaking user. The processor 28 of the terminal device 12 may estimate the user who is speaking.

A specific example will be described. As illustrated in FIG. 5, two users (that is, users E and F) are in the place β. It is registered in the server 10 that two users are in the place β. The user F is logged in to the online conference, and the user E is not logged in to the online conference.

The microphone of the terminal device 12F logged in to the online conference is turned on, and the microphone of the terminal device 12E which is not logged in to the online conference is turned off. In this case, in a case where the voice is collected by the microphone of the terminal device 12F, and it is determined that the user F does not speak based on the image or the moving image generated by photographing of the camera (for example, in-camera) of the terminal device 12F, the processor 20 of the server 10 estimates that the user E who is the remaining one person is speaking. The processor 28 of the terminal device 12F may estimate that the speaking user is the user E.

In a case where only one user is in the same place and participates in the online conference, and sound collection is performed when the one user does not speak, the processor 20 of the server 10 may stop the sound collection.

A specific example will be described. As illustrated in FIG. 6, only one user G is in the place γ. The microphone of the terminal device 12G is turned on. In this case, in a case where the sound is collected by the microphone of the terminal device 12G, and it is determined that the user G does not speak based on the image or the moving image generated by photographing of the camera (for example, in-camera) of the terminal device 12G, the processor 20 of the server 10 stops the sound collection by the microphone of the terminal device 12G. Stopping sound collection includes turning off the microphone, setting the microphone to mute, or not outputting data of the collected sound. In a case where a sound is collected regardless of the user G not speaking, it is supposed that the collected sound is required not to be transmitted to other users via the online conference. In this case, it is possible to prevent the occurrence of a situation in which a sound required not to be transmitted to other users is transmitted to the other users, by stopping sound collection. The processor 28 of the terminal device 12G may stop the sound collection by the microphone.

An example of the screen for an online conference will be described with reference to FIG. 7. FIG. 7 is a diagram illustrating a screen 38 for an online conference. FIG. 7 illustrates the display 30 provided in the place α. The screen 38 is displayed on the display 30. The same screen as the screen 38 is displayed on the respective displays of the terminal devices 12A to 12G and the display 36 provided in the place β.

A display region assigned to the user logged in to the online conference is formed on the screen 38. For example, the users D, F, and G are logged in to the online conference. A display region 38A is assigned to the user D, a display region 38B is assigned to the user F, and a display region 38C is assigned to the user G. The display regions 38A, 38B, and 38C are formed on the screen 38. In the display region 38A, an image or a moving image generated by photographing of the camera (for example, camera 34 provided in the place α or camera of the terminal device 12D) associated with the user D is displayed. In the display region 38B, an image or a moving image generated by photographing of the camera (for example, camera provided in the place β or camera of the terminal device 12F) associated with the user F is displayed. In the display region 38C, an image or a moving image generated by photographing of the camera (for example, camera provided in the place γ or camera of the terminal device 12G) associated with the user G is displayed. The image or the moving image maybe displayed, or a text string for identifying the user who is logged in may be displayed without displaying the image or the moving image. The displayed image or moving image may not be the image or the moving image generated by photographing of the camera, but may be an image or a moving image schematically representing the user.

Information (for example, account information) for identifying the user who is logged in to the online conference may be displayed on the screen 38. Here, the users D, F, and G are logged in to the online conference. Thus, pieces of information for identifying the users D, F, and G are displayed on the screen 38.

For example, an image or a moving image generated by photographing of the camera 34 provided in the place α is displayed in the display region 38A. In a case where the user A who is not logged in to the online conference speaks in the place α, the processor 20 of the server 10 displays the utterance made by the user A in the display region 38A. For example, in a case where the image or the moving image representing the user A is not displayed in the display region 38A before the user A speaks (for example, in a case where the image or the moving image representing the user A is not displayed in the display region 38A without the user A being photographed by the camera 34), the processor 20 of the server 10 displays the image or the moving image representing the user A who is speaking, in the display region 38A. The processor 20 of the server 10 may cause the camera 34 to be directed to the user A to photograph the user A, and display the image or the moving image which is generated by the photographing and represents the user A, in the display region 38A. Alternatively, the processor 20 of the server 10 may display the image or the moving image representing the user A, which is registered in advance, in the display region 38A. In the example illustrated in FIG. 7, the image or the moving image representing the user A is displayed in the display region 38A. An image or a moving image representing the user F who is logged in to the online conference is displayed in the display region 38B. An image or a moving image representing the user G who is logged in to the online conference is displayed in the display region 38C.

In a case where the image or the moving image representing the user A is displayed in the display region 38A before the user A speaks (for example, in a case where the user A is photographed by the camera 34, and the image or the moving image representing the user A is displayed in the display region 38A), the processor 20 of the server 10 may enlarge and display the image or the moving image representing the user A on the screen 38. The processor 20 of the server 10 may decorate the image or the moving image representing the user A or blink the image or the moving image representing the user A. Alternatively, the processor 20 of the server 10 may form a display region different from the display regions 38A, 38B, and 38C on the screen 38, and may display the image or the moving image representing the user A in this formed display region.

The processor 20 of the server 10 may display the image or the moving image representing the user A who is speaking, or display a text string indicating that the user A is speaking, on the screen 38 without displaying the image or the moving image representing the user A.

### EXAMPLE 2

Example 2 will be described below. Similar to Example 1, in Example 2, the users A, B, C, and D participate in an online conference in the place α, the users E and F participate in the online conference in the place β, and the user G participates in the online conference in the place γ.

In Example 2, the users A to G log in to the online conference and participate in the online conference. A camera (for example, in-cameras) is provided in each of the terminal devices 12A to 12G, and an image or a moving image generated by shooting by the camera provided in each terminal device 12 is displayed on the screen for the online conference.

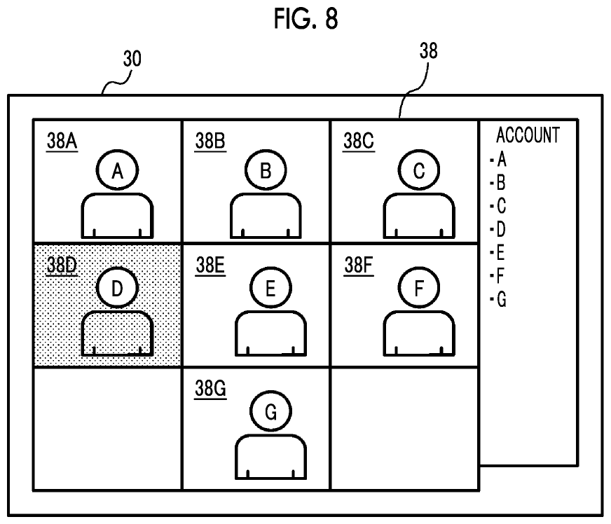

FIG. 8 illustrates the screen 38 for the online conference. The screen 38 illustrated in FIG. 8 is displayed on the display 30 provided in the place α. The same screen as the screen 38 is displayed on the display 36 provided in the place β and the display of each terminal device 12.

Since the users A to G are logged in to the online conference, display regions are respectively assigned to the users A to G, and the respective display regions of the users are formed on the screen 38. As illustrated in FIG. 8, display regions 38A to 38G are formed on the screen 38. The display regions of all logged-in users may be formed on the screen 38, or the display regions of some users maybe formed on the screen 38. For example, display regions corresponding to a predetermined number of persons may be formed on the screen 38.

The display region 38A is assigned to the user A, and an image or a moving image generated by photographing of the camera of the terminal device 12A is displayed in the display region 38A. The display region 38B is assigned to the user B, and an image or a moving image generated by photographing of the camera of the terminal device 12B is displayed in the display region 38B. The display region 38C is assigned to the user C, and an image or a moving image generated by photographing of the camera of the terminal device 12C is displayed in the display region 38C. The display region 38D is assigned to the user D, and an image or a moving image generated by photographing of the camera of the terminal device 12D is displayed in the display region 38D. The display region 38E is assigned to the user E, and an image or a moving image generated by photographing of the camera of the terminal device 12E is displayed in the display region 38E. The display region 38F is assigned to the user F, and an image or a moving image generated by photographing of the camera of the terminal device 12F is displayed in the display region 38F. The display region 38G is assigned to the user G, and an image or a moving image generated by photographing of the camera of the terminal device 12G is displayed in the display region 38G. Information for identifying the user may be displayed in each display region together with the image or the moving image or without displaying the image or the moving image.

In the example illustrated in FIG. 8, the image or the moving image representing the user is displayed in each display region. For example, the image or the moving image representing the user A is displayed in the display region 38A. The image or the moving image representing the user A may be the image or the moving image generated by photographing of the camera of the terminal device 12A, or may be an image or a moving image schematically representing the user A. This is similarly applied to the display regions 38B to 38G.

A list of information (for example, account information) for identifying the user who is logged in to the online conference is displayed on the screen 38. Here, as an example, since the users A to G are logged in to the online conference, a list of pieces of account information of the users A to G is displayed.

In a case where the user is designated, and then the designated user speaks, the processor 20 of the server 10 shows that the designated user is speaking, in the online conference. For example, the processor 20 of the server 10 displays an image or a moving image displayed in a display region associated with the designated user, or changes the display form of the display region, so as to represent that the designated user is speaking. Specifically, the processor 20 of the server 10 may expand the display region (associated with the designated user) up to a size corresponding to a point that the designated user is speaking, or may enlarge the image or the moving image displayed in the display region up to a size corresponding to the point that the designated user is speaking. The processor 20 may decorate (for example, surround the display region in a frame of a specific color or shape) the display region corresponding to the point that designated user is speaking, may blink the display region, the image, or the moving image, or may highlight the display region, the image, or the moving image by other methods.

For example, in a case where a user speaks and a voice is collected by the microphone, the display region associated with the user is enlarged, the display region is decorated, or an image or a moving image displayed in the display region is enlarged.

The processor 28 of the terminal device 12 used by the speaking user may perform processing of highlighting the display region, the image, or the moving image associated with the speaking user. Alternatively, the processor 28 of the terminal device 12 that has received data of the voice may perform the processing.

In the example illustrated in FIG. 8, the user D is designated and speaks, and the display region 38D associated with the user D blinks, or is decorated. Alternatively, the image or the moving image displayed in the display region 38D blinks. For example, the frame of the display region 38D is shown by a color (for example, red) corresponding to a point that the user D is speaking. As another example, the image or the moving image of the user D may be enlarged and displayed.

The processor 20 of the server 10 may transmit a message indicating that the user D is designated and speaks, to other users by sound or vibration. For example, the processor 20 of the server 10 may output a voice indicating that the user D is designated and speaks, from the speaker of each terminal device 12. The processor 20 may transmit a message indicating that the user D is designated and speaks, to other users by bone conduction using a hearable device.

The user who speaks next is designated by the user who speaks before the user who speaks next, an authorized person having the authority to designate the speaker, or the like. The user who previously speaks may be the user who speaks immediately before the user who speaks next, or may be the user who speaks before the above user. The authorized person is, for example, the moderator or the organizer of the online conference.

The user who speaks next maybe designated, for example, on the screen 38, by a sound such as a voice, by a gesture such as pointing, or by a sight line.

In a case where the user who speaks next is designated on the screen 38, the display region associated with the user who speaks next may be designated, or the image or the moving image displayed in the display region may be designated. Alternatively, the account information of the user who speaks next maybe designated from the list of the account information. The processor 20 of the server 10 receives the designation and recognizes the user who speaks next. For example, in a case where the display region 38D associated with the user D is designated, the image or the moving image displayed in the display region 38D is designated, or the account information of the user D is designated from the list of the account information, the processor 20 of the server 10 receives the designation and recognizes that the user D is the user who speaks next.

In a case where the user who speaks next is designated by voice, and in a case where the user who previously speaks, the authorized person, or the like calls the name, the account information, the nickname, or the like of the user who speaks next, by voice, the voice is collected by the microphone, and the processor 20 of the server 10 identifies the user who speaks next, based on the voice. For example, in a case where the name of the user D is called by voice, the processor 20 of the server 10 identifies the user D as the user who speaks next.

In a case where the user who speaks next is designated by a gesture such as pointing, and in a case where the user who previously speaks or the authorized person points to the user who speaks next with a finger or an arm, such a situation is photographed by the camera. The processor 20 of the server 10 analyzes the image or the moving image generated by the photographing to identify the pointed user as the user who speaks next. For example, in a case where the user D is pointed, the processor 20 of the server 10 identifies the user D as the user who speaks next.

In a case where the user who speaks next is designated by the sight line, and in a case where the user who previously speaks, the authorized person, or the like causes the sight line to be directed to the user who speaks next, such a situation is photographed by the camera. The processor 20 of the server 10 analyzes the image or the moving image generated by the photographing to identify the user who is in the sight line, as the user who speaks next. For example, in a case where the user in the sight line is the user D, the processor 20 of the server 10 identifies the user D as the user who speaks next.

The processor 28 of the terminal device 12 may identify the user who speaks next.

The processor 20 of the server 10 may set the length of time for which the designated user speaks. In a case where the time elapses, the processor 20 may forcibly end the utterance of the user. In a case where an end button is displayed on the screen 38 and the end button is pressed, the processor 20 of the server 10 may forcibly end the utterance of the designated user. The end of the utterance of the designated user may be instructed by voice. In a case where the length of time for which the designated user is silent is equal to or greater than a threshold value, the processor 20 of the server 10 may forcibly end the utterance of the user. In a case where the utterance of the user is forcibly ended, the processor 20 of the server 10 stops processing representing that this user is the speaker. In a case where the next user is designated, the processor 20 of the server 10 shows that the next user is the user who speaks next, in the online conference.

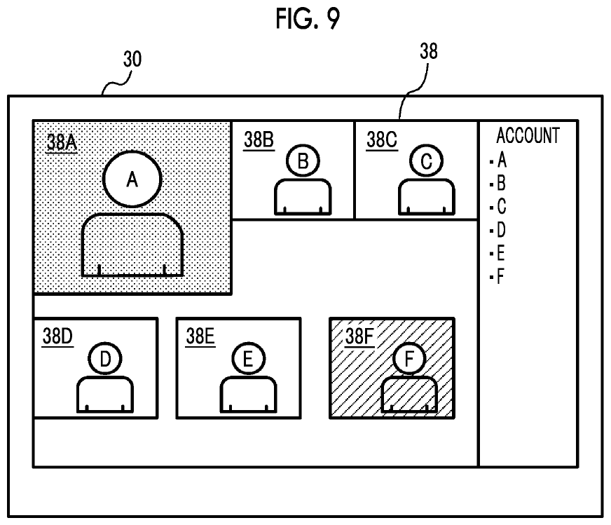

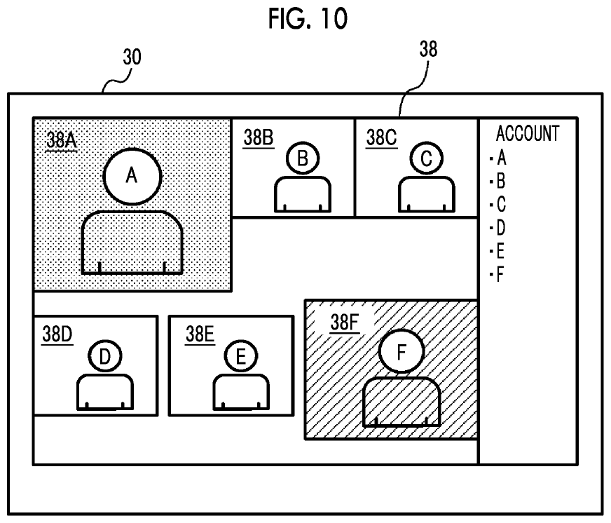

The processor 20 of the server 10 may show, in the online conference, information indicating that the user is designated as the user who speaks next. Regarding the method of showing, similar to the methods described above, the information may be shown on the screen 38, by sound such as a voice, or by vibration. This processing will be described below with reference to FIGS. 9 to 12. FIGS. 9 to 12 illustrate the screen 38 for the online conference.

As an example, the users A, B, C, and D participate in an online conference in the place α, and the users E and F participate in the online conference in the place β. The users A to F log in to the online conference and participate in the online conference.

The screen 38 illustrated in FIG. 9 is displayed on the display 30 provided in the place α. The same screen as the screen 38 is displayed on the display 36 provided in the place β and the respective displays of the terminal devices 12A to 12F.

The users A to F are logged in to the online conference, and thus the display regions 38A to 38F are formed on the screen 38.

In the example illustrated in FIG. 9, the user A is speaking, and the display region 38A is expanded to a size corresponding to a point that the user A is speaking. In response to the expansion of the display region, the image or the moving image displayed in the display region 38A is also enlarged and displayed. For example, the image or the moving image representing the user A is enlarged and displayed. The display region 38A may be decorated or blink to recognize that the user A is speaking. For example, the frame of the display region 38A is shown by a color (for example, red) corresponding to a point that the user A is speaking.

The user F is the user designated as the user who speaks next. The processor 20 of the server 10 may show, in the online conference, that the user F is designated as the user who speaks next. That is, the user F is the user reserved as the user who speaks next, and the processor 20 of the server 10 shows the reservation in the online conference.

For example, the processor 20 of the server 10 displays the image or the moving image displayed in the display region 38F associated with the user F or changes the display form of the display region 38F, so as to represent that the user F is designated as the user who speaks next. Specifically, the processor 20 of the server 10 may show the display region 38F with a size or a color (for example, size or color in accordance with the reservation) corresponding to a point that the user F is designated as the user who speaks next. The processor 20 may display the image or the moving image displayed in the display region 38F with the size or the color corresponding to the point that the user F is designated as the user who speaks next. Alternatively, the processor 20 may perform decoration (for example, decoration in accordance with the reservation) on the display region 38F corresponding to the point that the user F is designated as the user who speaks next, or may blink the display region 38F, the image, or the moving image in accordance with the reservation. In this manner, the processor 20 of the server 10 displays that the user F is reserved as the user who speaks next. A message indicating that the user F is reserved as the user who speaks next may be transmitted to other users by sound, vibration, or the like.

In the example illustrated in FIG. 9, the display region 38F is displayed with a color in accordance with the reservation. For example, the display region 38A associated with the user A who is speaking is expanded, and the frame of the display region 38A is shown by a color (for example, red) indicating that the user A is speaking. The frame of the display region 38F associated with the user F who speaks next (that is, the reserved user F) is shown by a color (for example, blue) corresponding to the point that the user F is reserved as the user who speaks next. In this manner, the user who is speaking and the user who speaks next are distinguished from each other by the color, the size, the decoration, and the like.

The users who speak the third and subsequent time may be designated. In this case as well, images and moving images may be displayed in colors corresponding to the order, and decorations corresponding to the order may be applied to the respective display regions.

The processor 20 of the server 10 may gradually change the display form of the display region 38F of the user F designated as the user who speaks next, with time. The processor 20 of the server 10 may gradually increase the size of the display region 38F, or gradually bring the color of the frame of the display region 38F closer to red (that is, color showing that the user is speaking). For example, in a case where the length of time for which the user A speaks is defined, the processor 20 of the server 10 may increase the size of the display region 38F or bring the color of the frame of the display region 38F closer to red, as the time approaches the end time of the user A speaking.

For example, in a case where time elapses from the time point at which the user F is designated as the user who speaks next, as illustrated in FIG. 10, the display region 38F is expanded in comparison to the size of the display region at the time point at which the user F is designated. In response to this expansion, the image or the moving image displayed in the display region 38F is also enlarged and displayed.

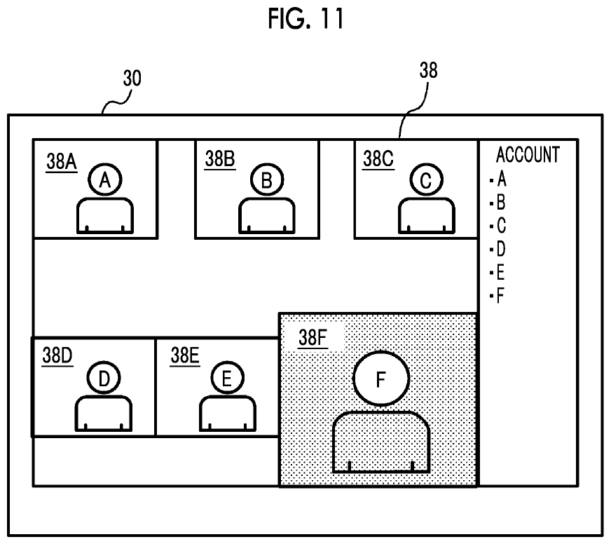

In a case where the time for which the user A speaks ends, and the time for which the user F speaks starts, as illustrated in FIG. 11, the display region 38F is expanded up to a size corresponding to a point that the user F is the speaker. In response to this expansion, the image or the moving image displayed in the display region 38F is also enlarged up to a size corresponding to the point that the user F is the speaker. In the example illustrated in FIG. 11, the time for which the user A speaks has ended. Thus, the size of the display region 38A is reduced to the size when the user A does not speak. In response to this reduction, the image or the moving image displayed in the display region 38A is also reduced to the size when the user A does not speak.

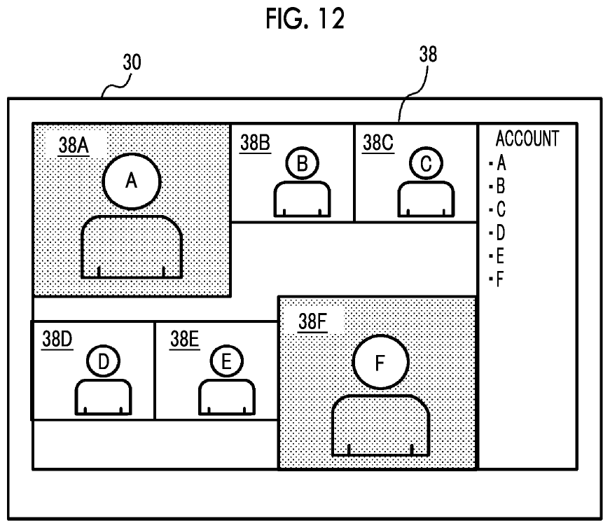

In a case where the user speaks without making a reservation, the processor 20 of the server 10 may show that the user who makes the utterance is speaking, in the online conference. For example, in a case where the user A speaks without making a reservation under circumstances illustrated in FIG. 11 (that is, while the user F is speaking with the reservation), as illustrated in FIG. 12, the processor 20 of the server 10 expands the size of the display region 38A up to a size for showing that the user A is the speaker. The processor 20 of the server 10 may not output the utterance of the user A who does not make a reservation, from the speaker of each terminal device 12 and not change the display form of the display region 38A.

### EXAMPLE 3

Example 3 will be described below. Similar to Example 1, in Example 3, the users A, B, C, and D participate in an online conference in the place α, the users E and F participate in the online conference in the place β, and the user G participates in the online conference in the place γ.

In Example 3, the order of each user speaking is designated (for example, the order is reserved), the processor 20 of the server 10 switches the user to speak, in the order. In this case, the processor 20 of the server 10 may cause the user to speak to log in to the online conference.

For example, in the example illustrated in FIG. 4, it is determined that the users A, B, C, and D speak in this order, and the order is registered in the server 10. The processor 20 of the server 10 switches the user to speak, in this order. For example, in a case where the length of time for which each user speaks is defined, the processor 20 of the server 10 switches the user to speak in accordance with the length of time for which each user speaks. In this case, the processor 20 of the server 10 switches the image (which may be a moving image or schematic image) of the user displayed on the screen for the online conference, in order. For example, the processor 20 of the server 10 displays the image of the user of which the turn of speaking comes, on the screen for the online conference, and changes the image of the user, which is to be displayed, in the order of speaking. In the above example, the images of the users A, B, C, and D are switched in the order of the users A, B, C, and D. The processor 20 of the server 10 may cause the user of which the turn comes to log in to the online conference and cause other users to log out from the online conference. In the above example, the logged-in user is switched in the order of the users A, B, C, and D. In this order, the account of the user logged in to the online conference is switched.

The order of speaking may be any order. For example, the same user may consecutively speak a plurality of times, or the order may be determined between different places. For example, the user A may consecutively speak twice, and then the user B may consecutively speak three times. The users A and B in the place α, the user F in the place β, and the user G in the place γ may speak in this order.

### EXAMPLE 4

Example 4 will be described below. In Example, 4, the users A, B, C, and D participate in an online conference in the place α, and the users E and F participate in the online conference in the place β. The users A to F log in to the online conference and participate in the online conference.

In Example 4, in a case where the order of each user speaking is designated (for example, in a case where the order is reserved), the processor 20 of the server 10 may show the image (which may be a moving image or schematic image) of the user in the online conference in a form corresponding to the order. For example, the processor 20 of the server 10 displays the image of each user by changing the color, the size, and/or the combination thereof corresponding to the order.

For example, it is determined that the users A, B, C, D, E, and F speak in this order (for example, the order is reserved), and the order is registered in the server 10. The processor 20 of the server 10 displays the image of each user in a form corresponding to the order.

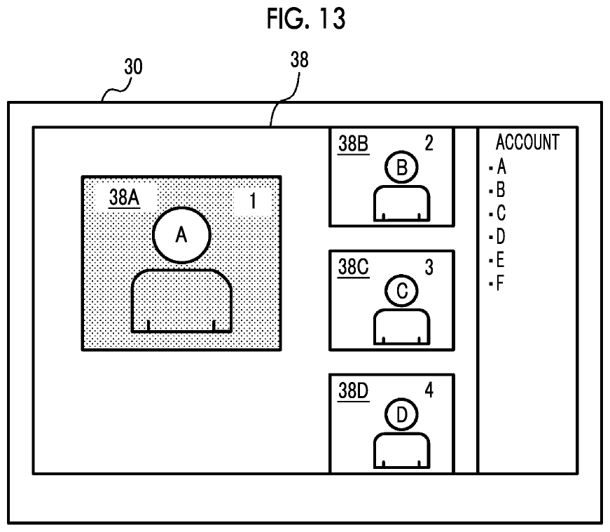

FIGS. 13 to 15 illustrate examples of displaying the image of each user. FIGS. 13 to 15 illustrate the screen 38 for the online conference displayed on the display 30. A screen similar to the screen 38 is displayed on the display 36 and the displays of the terminal devices 12A to 12F.

In the example illustrated in FIG. 13, the display regions 38A, 38B, 38C, and 38D are formed on the screen 38, and the processor 20 of the server 10 arranges the display regions in the order of speaking. The processor 20 of the server 10 expands the display region of the user who is speaking (that is, display region of the user of which the turn of speaking comes) in comparison to the display regions of the other users.

Since the user A speaks first and is speaking, the display region 38A is expanded in comparison to the other display regions. In response to such expansion, the image and the moving image displayed in the display region 38A (for example, image or moving image representing the user) is enlarged and displayed. The processor 20 of the server 10 may perform decoration (corresponding to the point that the user A is the user who is speaking) on the display region 38A, or may show the image or the moving image of the user A by the color, light, or the like corresponding to the point that the user A is the user who is speaking.

The user B speaks second, the user C speaks third, and the user D speaks fourth. Thus, the display regions 38B, 38C, and 38D are disposed in accordance with the order. Since the space of the screen 38 is limited, the images of the fifth and subsequent users are not displayed on the screen 38.

A text string or the like indicating the order may be displayed in each display region. For example, the number “1” is displayed in the display region 38A, and the number “2” is displayed in the display region 38B. This is similarly applied to the other display regions.

The list of pieces of account information of the users is displayed on the screen 38, and the account information of each user is disposed in the list in the order of speaking.

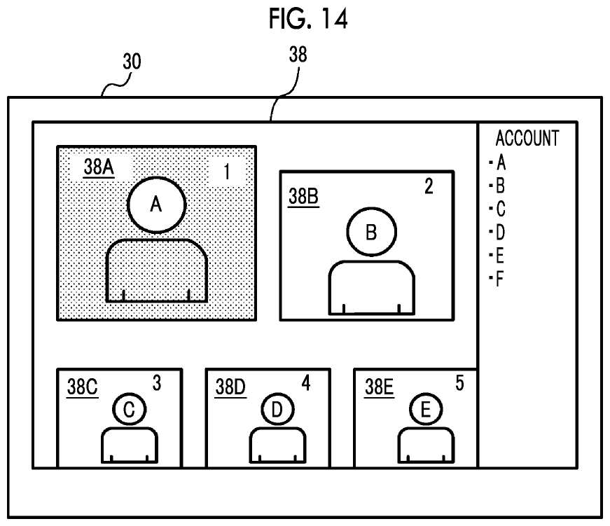

The length of time for which each user speaks is defined. In a case where the time approaches the time for which the user B who speaks next is to speak, as illustrated in FIG. 14, the processor 20 of the server 10 expands the display region 38B to a size corresponding to the point that the user B is the user who speaks next, and enlarges and displays the image or the moving image displayed in the display region 38B. In response to the enlargement, the processor 20 of the server 10 may change the arrangement of the display regions. In a case where a space is secured on the screen 38 with this change in arrangement, a display region of a user who has not been displayed until now may be displayed on the screen 38. In the example illustrated in FIG. 14, a display region 38E associated with the fifth user E is displayed on the screen 38, and an image, a moving image, or the like of the user E is displayed in the display region 38E.

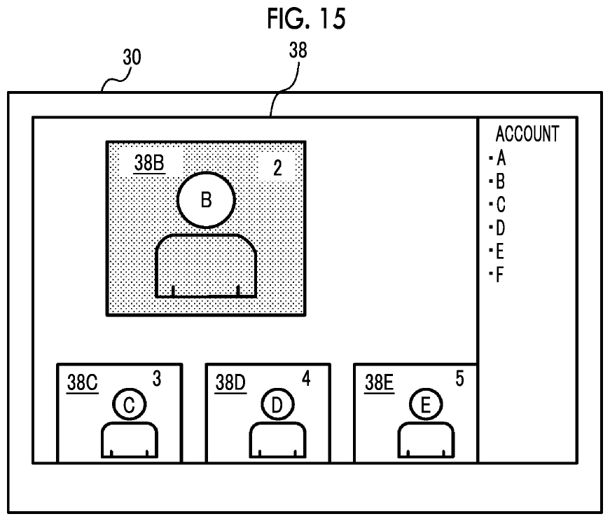

In a case where the time for which the user A speaks is ended, and the turn of the user B speaking comes, as illustrated in FIG. 15, the processor 20 of the server 10 expands the display region 38B up to the size corresponding to the point that the user B is speaking. In response to such expansion, the processor 20 enlarges and displays the image or the moving image displayed in the display region 38B. The processor 20 of the server 10 may perform decoration (corresponding to the point that the user B is the user who is speaking) on the display region 38B, or may show the image or the moving image of the user B by the color, light, or the like corresponding to the point that the user B is the user who is speaking.

As illustrated in FIG. 15, the processor 20 of the server 10 may not display the display region 38A associated with the user A who has finished speaking, on the screen 38. In a case where the user A finishes speaking, the display region 38A may be reduced and displayed on the screen 38.

### OTHER EXEMPLARY EMBODIMENTS

In a case where a user introduces himself/herself when an online conference is started, the processor 20 of the server 10 may identify the user based on the self-introduction and register the identified user as a user who participates in the online conference. For example, in a case where a user introduces himself/herself by sound, the processor 20 of the server 10 identifies the user by voice. Further, in a case where information for identifying a user (for example, name, user ID, or account information) is included in the self-introduction, the processor 20 of the server 10 may identify the user based on the information.

In a case where the beginning and end of the utterance of the speaking user are designated by a user (for example, moderator, organizer, or authorized person), the processor 20 of the server 10 may switch the image of the user who is speaking in accordance with the designation.

The processor 20 of the server 10 may exclude a user from candidates for the user who speaks. The user who manually inputs a text with an input device (for example, keyboard) of the terminal device 12 may be excluded. For example, a user who is typing with a keyboard is highly likely to create the minutes, memos, and the like, and is highly likely not to speak. Thus, the processor 20 of the server 10 excludes such a user from candidates for the user who speaks, and specifies the user who speaks among users other than such a user. For example, in a case where a user who speaks is identified based on a voice, an image, or the like, a user who is typing with a keyboard is excluded from the candidates for the user who speaks, and the user who speaks is specified among users other than such a user.

The processor 20 of the server 10 may exclude, from the candidates for the user who speaks, a user who uses application software different from application software for using the online conference. For example, each user uses application software for an online conference, which is installed on the terminal device 12 of each user, to participate in the online conference. Application software other than the application software for the online conferences is installed on the terminal device 12. It is supposed that a user who starts and operates application software other than the application software for the online conference does not intend to participate in the online conference or has a weak intention. Thus, the processor 20 of the server 10 excludes such a user from the candidates for the user who speaks and specifies the user who speaks among other users.

It is supposed that a user who searches for information related to the online conference by using a Web browser intends to participate in the online conference. Thus, the processor 20 of the server 10 may not exclude such a user from the candidates for the user who speaks.

The functions of the units of the server 10 and the terminal device 12 are realized by the cooperation of hardware and software as an example. For example, the processor of each device reads and executes the program stored in the memory of each device to realize the functions of each device. The program is stored in the memory via a recording medium such as a CD or a DVD, or via a communication path such as a network.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device). In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a processor configured to:
in a case where another user other than a user logging in to an online conference speaks in the online conference, show that the other user is speaking, in the online conference.

2. The information processing apparatus according to claim 1,
wherein the user logging in to the online conference and the other user are in the same place.

3. The information processing apparatus according to claim 1,
wherein the user logging in to the online conference and the other user share at least one device used for participating in the online conference.

4. The information processing apparatus according to claim 2,
wherein the user logging in to the online conference and the other user share at least one device used for participating in the online conference.

5. The information processing apparatus according to claim 1, wherein the processor is configured to:
identify a speaking user based on information of a face of the user.

6. The information processing apparatus according to claim 2, wherein the processor is configured to:
identify a speaking user based on information of a face of the user.

7. The information processing apparatus according to claim 1, wherein the processor is configured to:
identify a speaking user based on a voice of the user.

8. The information processing apparatus according to claim 1, wherein the processor is configured to:
cause the other user to log in to the online conference.

9. The information processing apparatus according to claim 1, wherein the processor is further configured to:
in a case where sound collection is performed with a microphone for collecting a voice of the user when a user does not speak, estimate that another user speaks.

10. The information processing apparatus according to claim 1, wherein the processor is further configured to:
in a case where only one user is in the same place and participates in the online conference, and sound collection is performed when the one user does not speak, stop the sound collection.

11. The information processing apparatus according to claim 1, wherein the processor is further configured to:
in a case where the other user is designated and then the other user speaks, show that the other user speaks, in the online conference.

12. The information processing apparatus according to claim 11,
wherein the other user is designated by a user who has spoken before the other user.

13. The information processing apparatus according to claim 11,
wherein the other user is designated by an authorized person who has an authority to designate a speaker.

14. The information processing apparatus according to claim 11, wherein the processor is further configured to:
show information indicating that the other user is designated, in the online conference.

15. The information processing apparatus according to claim 1, wherein the processor is further configured to:
in a case where a speaking order of each user is designated, show an image of each user in a form corresponding to the order, in the online conference.

16. The information processing apparatus according to claim 1, wherein the processor is further configured to:
in a case where a speaking user is switched in a predetermined order, switch a user image displayed in the online conference in accordance with the order.

17. The information processing apparatus according to claim 1, wherein the processor is further configured to:
exclude a user who manually inputs text with an input device, from candidates for a speaking user.

18. The information processing apparatus according to claim 1, wherein the processor is further configured to:
exclude a user who uses application software different from application software for the online conference, from candidates for a speaking user.

19. A non-transitory computer readable medium storing a program causing a computer to execute a process comprising:
showing, in a case where another user other than a user logging in to an online conference speaks in the online conference, that the other user speaks, in the online conference.

20. An information processing method comprising:
showing, in a case where another user other than a user logging in to an online conference speaks in the online conference, that the other user speaks, in the online conference.
